(19) United States
(12) Patent Application Publication
(10) Pub. No.: US 2004/0040372 A1
(43) Pub. Date: Mar. 4, 2004

(54) Method for determining the permeation of gases into or out of plastic packages and for determination of shelf-life with respect to gas permeation

(76) Inventors: George Plester, Waterloo (BE); Horst Ehrich, Dorsten (DE); Thomas Schoensee, Essen (DE)

Correspondence Address: SUTHERLAND ASBILL & BRENNAN LLP, 999 PEACHTREE STREET, N.E., ATLANTA, GA, 30309, US

(21) Appl. No.: 10/234,634

(22) Filed: Sep. 4, 2002

Related U.S. Application Data
(60) Provisional application No. 60/407,374, filed on Aug. 30, 2002.

(51) Int. Cl. G01N 15/08

(52) U.S. Cl. 73/38

(57) ABSTRACT

Testing of gas permeability and shelf-life characteristics of plastic packages by determining a quantity of gas permeated through the packages and thereafter determining the permeation rate and calculating the shelf-life based on permeation rate and other characteristics of the package. Preferred embodiments provide determination of shelf-life based on permeation rate of gas out of or into a package.

### TECHNICAL FIELD

This invention relates to testing of gas permeability of plastic packaging and shelf life of substances, particularly food products and especially beverages, packaged in plastic packaging.

### BACKGROUND OF THE INVENTION

Increasingly, products are packed in plastic packages, because these are light and convenient. This trend is reflected by carbonated beverages, which are frequently packed in PET bottles. Plastic packaging has the disadvantage that it is not as impermeable as glass or metal. Therefore, plastic packaging can permit limited amounts of diffusion, which in turn can affect the “shelf-life” of the product.

“Shelf-life” is the common term, which describes the time during which the product retains its properties. Permeation of gases, particularly oxygen, into the package, and permeation of volatile product components out of the package play a principal role in shelf-life of products packaged in plastic, because other mechanisms leading to product deterioration are normally slower. For the purposes of the present invention, gas permeation is therefore assumed to be the controlling mechanism for determining shelf-life in plastic packages.

Diffusion through the walls of the package can take place inwards and outwards. This involves gaseous components of the product itself, which can diffuse outwards, as well as air and contaminants, which can diffuse inwards. It is therefore important to be able to measure the gas permeation of plastic packaging, so as to determine the barrier property of the plastic against such gas permeation, as well as to determine the shelf-life of the product in the package.

PET bottles and other packages are subjected to barrier treatments, which are frequently coatings. In the development of such treatments, it is important to determine the permeation rates of those gases, which affect shelf-life, and to use this data to evaluate the barrier improvement of said barrier treatments by reference to an untreated package. In production of barrier-treated packages, it is a quality control necessity to be able to measure the permeation and shelf-life of said packages on a regular basis. For quality control, it is desirable to be able to test packages, straight off the production line, without opening the package. Therefore, both for research/development and for production quality-control, a barrier and shelf-life measurement system is needed that gives quick results, can handle many samples daily, with a wide range of package sizes, can be used on un-opened production packages or specially-prepared test-packages, avoids need for highly-trained operators and requires minimum involvement of operators.

Several technologies exist for measuring the barrier property of complete packages, such as bottles, and/or wall-sections taken from these packages and/or materials used in the packages. For example, one known system intermittently flushes one side of a package with an inert gas (eg nitrogen), whilst maintaining an atmosphere of the permeating gas on the other side of the package. Permeation rate is measured by continuously or intermittently exhausting the inert gas at a measured rate and monitoring the concentration of the permeating species within this exhaust, until equilibrium is reached, at which time-point the permeation rate is essentially constant. One example of this basic system is covered by a series of U.S. Pat. Nos. (4,852,389, 5,390,539, 5,265,463, 5,591,898, 5,513,515, 5,081,863, 5,837,888). A further example is covered by Japanese patent (# 110 305 79A). The system suffers from significant inaccuracies when the permeation rate is very low, partly because it compounds the inaccuracy of the gas-concentration measuring device at necessarily low concentrations with the inaccuracy of the gas flow device. In addition, the system has limited capacity, because each package must be installed in the equipment and continuously monitored until equilibrium is measured.

Other systems rely on measuring the loss of permeating gas within a package. An example of this is the common practice of mounting a pressure gauge on a pressurised package, measuring the rate of loss in pressure within the package and equating this to the permeation rate. These systems often find application in the testing of PET beverage bottles. More recently, non-invasive methods of measuring the loss of gas within a package have been developed using IR spectroscopy. U.S. Pat. Nos. 5,614,718 & 5,473,161 provide examples of this basic approach. Such systems, which measure the loss of gas within a package, have the disadvantage of requiring very long test-periods, generally of the order of weeks, in order to provide an accurate measure of permeation rate, because the proportional change within the package is normally very small, when, as in case of PET bottles, the package exhibits only very low permeation.

Many available systems, can only measure permeation rate on gas-filled packages, and this is itself a compromise, when a measurement of shelf-life is required. For shelf-life, it is better to measure the permeation rate of one or several components of the product, whilst the package is filled normally with product and also sealed with its normal closure. The reason for this is that the product, in combination with all the permeating gases, which normally include water vapour, may interact and result in a different permeation effect than that measured in a package which is filled only with gas. Further, the package's closure can affect gas permeation. It is often desirable to test product-filled packages taken direct from a production line, as this gives a “real life” assessment. Most available systems do not permit this.

Especially when using the permeation results to compute shelf-life, it is often desirable to subject a product-filled package to selected ambient conditions of temperature and pressure, and most available systems either do not have this facility at all, or make its provision complex. The need may be explained by the fact that some products, particularly carbonated beverages, exert a significant in-package pressure, resulting in package expansion. In-package pressure can affect the basic barrier property of a packaging material (eg of a coated or multi-layer bottle), because package-wall expansion can affect the integrity of thin coatings or layers within its structure, whilst the barrier property even of single-material structures can also be affected by stretching.

Additionally, increased ambient temperature increases the vapour pressure of volatile components in the packaged product, and this in itself results in higher permeation rates, even in non-pressurised packages. Furthermore, package expansion can affect the product's shelf-life by permitting the additional passage of volatile components from the product into the package's headspace. Finally, package expansion is not only dependent on in-package pressure, because ambient humidity can also affect the degree expansion of a pressurised package, such as a PET-bottle containing a carbonated beverage, because humidity can affect the packaging material's Young's Modulus.

For shelf-life computation, it is important to include the effect of absorption of product components within the package's walls, as well as the effect of package expansion. For example, in the case of carbonated beverages packed in PET-bottles, a significant amount of carbon dioxide is “lost” due to absorption in the bottle walls, and a further amount is “lost” into the headspace. Although theses are not entirely non-reversible losses, they can still affect shelf-life. Existing systems do not adequately cover these effects.

Shelf-life and permeation measurement systems must provide the flexibility needed in development, as well as enable in quality-control monitoring, and most existing systems do not provide this. For package development purposes, it is desirable to be able to measure gas-filled packages, as well as product-filled packages, because it is often necessary to differentiate the permeation effects. In development, it is also sometimes necessary to measure wall-sections or film. Both for development and for production-line quality-control, it is normally necessary to have the ability to measure many samples per working day, and to obtain results quickly, accurately and with minimum operator intervention.

The output of existing systems is often limited, for example because some systems necessitate that the test-package remains connected to the measuring apparatus for the entire permeation period, until a result is obtained. U.S. Pat. Nos. 5,792,940 & 6,116,081 provide an example of this. Additionally, these patents cover a system that can only test bottles filled with a single gas, and cannot test product-filled samples, further restricting flexibility. A further example, with similar disadvantages, is PCT/EP00/13139 (W/O 01/48452), which furthermore needs change-parts and re-establishment for each package size, involving a lot of cost, operator intervention and downtime. Finally, the said system suffers from inaccuracy, because the measurement is affected not only by permeation but also by spurious factors, such as bottle expansion.

It is often necessary, particularly with coatings, to compare the change in permeation properties of a package, either filled with gas or product, through various stages of handling, in the production line or in the market. Many systems (eg the above-mentioned U.S. Pat. Nos. 5,614,718 & 5,473,161, and PCT/EP00/13139:W/O 01/48452) do not permit this, since such systems demand that each permeation measurement must be carried out on a freshly-filled package.

In summary, existing permeation-testing technologies have one or more of the following inherent limitations:

slowness and/or inaccuracy when measuring low permeation rates.

high operator involvement and skill;

inability to measure both gas-filled and product-filled packages.

inability to measure packages, which are under internal pressure.

inability to measure normally-closed packages;

inability to measure un-opened packages direct from production line;

inability to measure many samples per day, without relatively high expense in equipment;

inability to simultaneously measure the permeation of several permeating components;

inability to measure a wide range of package sizes, without change-parts (and accompanying cost, downtime, operator involvement, etc);

inability to relate permeation results to a shelf-life, taking into account all factors, including in-package absorption and headspace expansion; and

inability to measure changes in permeation properties of a package through various stages in handling, without re-filling at each stage.

### SUMMARY OF THE INVENTION

This invention encompasses a method for the measuring permeation and shelf-life-preserving characteristics of packages, which is quick and applicable to a wide range of package sizes without change-parts. At least one embodiment can test un-opened packages direct from the production line. Preferred embodiments can measure multiple relevant permeating components of the product simultaneously. Preferred embodiments of the method are self-checking, require little operator intervention and training, and can be applied at relatively low cost to give results for a high volume of test-samples per day. In a preferred embodiment, pre-filled packages containing a test-substance, which can be either the product itself or a simulating substance, are inserted in one cell, or a series of cells, and permeating gases, which collect in said cells, are circulated past one, or several, devices for measuring the content of each gas. Preferred embodiments include means of purging air and gases from previous measurements, before each measurement cycle.

In accordance with a preferred embodiment of this invention, a package, filled with a test substance is placed within a test cell. The packaged test substance can be pressurised or un-pressurised, and at choice either closed by the normal closure or by a non-permeable closure, so as to determine the closure's effect. The test cell is fitted with one or a multiplicity of measuring devices, whereby the measuring device/devices, can accurately measure the quantity of permeating gas in the space between the cell walls and the exterior of the package placed inside the container. For example, in preferred embodiments, the measuring device can be an infra-red (IR) device for measuring CO2 and H2O content, or a surface-active probe (lambda probe) for measuring O2, or a flame-ionisation detector, or a mass-spectroscope, or other means specific and sensitive to the permeating gas. Where the package volume does not change and only one permeating gas is involved, a simple pressure gauge can be used to monitor permeating gas content. In some preferred embodiments, it is normally convenient to install the measuring devices in a piped circuit around the container, as described later herein.

In one preferred optional embodiment, a container is filled, either with a gas, or a mixture of gases or other simulating material, or the product itself, and sealed, before being put into the test cell. In another embodiment, a container can be fixed and sealed against one part of the cell, permitting the permeating gas to be supplied from an external, pressure-regulated gas source, so as to maintain in-container vapour pressure throughout the permeation measurement period. In this second embodiment, the container may be filled with a test substance including a permeating gas, or the product itself. In a third embodiment, one or more measurement devices can measure gas migration into the package (eg oxygen from the gases in the space between the cell walls and the container's outer skin). The basic principle defined herewith will enable the same apparatus to be simply converted between the above-mentioned embodiments so as to provide flexibility.

The rate of permeation can be measured either by a single measurement of total permeated quantity over a finite time-period, which is the preferred method, or by multiple measurements of permeated quantity at short time-intervals and computing the slope of the quantity/time curve. Where the permeating gas species is significantly absorbed by the package walls, as in case of carbon dioxide gas absorption in PET packages, permeation rate measurement starts after equilibrium absorption has taken place, when the permeation rate stays essentially constant over short periods.

For calculation of shelf-life with respect to gases permeating out of the package, the effect of package expansion, which can lead to losses of permeating gas into the package head-space, and the effect of package-wall saturation must be measured, where these effects are significant. This measurement need only be done once for each package type/design. The measurement is carried out by filling the package with gas at a pressure, which reflects normal package pressure, and then measuring the pressure-loss during the period of package expansion and wall-absorption. This proportional loss must then be deducted from the original package content, giving a net content after the initial post-filling period.

Therefore, in one embodiment of this invention, a method is disclosed for measuring the gas permeation and shelf-life of a packaged product by using of at least one packaged test substance comprising a sealed container and a test substance disposed in the container. The method comprises the steps of:

stabilizing the at least one packaged test substance so that the test substance permeates at a permeation rate out of the sealed container and the permeation rate of the test substance out of the sealed container is substantially free of effects of package expansion and saturation of container walls;

placing the at least one packaged test substance inside a first cell;

closing the first cell and displacing any air or unwanted gases from the first cell with a carrier gas different from the test substance;

filling the first cell with the carrier gas so that the carrier gas contacts the at least one packaged test substance and mixes with any of the test substance that permeates from the sealed container to form a gas mixture comprising the carrier gas and an amount of permeated test substance;

holding the at least one packaged test substance and the carrier gas in the first cell for at least a period of time sufficient for measurable permeation of the test substance out of the sealed container to occur;

thereafter, analysing the gas mixture to determine the amount of permeated test substance; and

determining the permeation rate of the test substance out of the sealed container based on analysis of the gas mixture.

Preferably, in the embodiment described hereinbefore, the step of stabilizing is conducted remotely from the first cell. Also preferably, the method includes the step of calculating the permeation rate of the test substance through the at least one packaged test substance when the sealed container is first filled with the test substance and sealed based on the permeation rate of the test substance as determined in the step of determining the permeation rate of the test substance out of the sealed container based on analysis of the gas mixture. Still more preferably, the method of this embodiment can include calculating shelf life of the at least one packaged test substance based on the permeation rate of the test substance as determined in the step of determining the permeation rate, a calculation of the permeation rate of the test substance through the sealed container when the sealed container is first filled with the test substance and sealed based on the permeation rate of the test substance as determined in the step of determining the permeation rate, and data on expansion and gas absorption characteristics on the at least one packaged test substance.

According to anther embodiment of this invention, a method is disclosed for measuring the gas permeation and shelf-life characteristics of at least one container having an opening, the method comprising the steps of:

placing the at least one container inside a first cell having a gas inlet and a gas outlet so that the at least one container is fixed and sealed to the first cell so as to seal an interior of the container from a space inside the first cell between the first cell and the at least one container;

closing the first cell;

filling the at least one container with a test substance and displacing any air and unwanted gases from the at least one container;

stabilizing the at least one container so that the test substance permeates at a permeation rate out of the at least one container and the permeation rate of the test substance out of the at least one container is substantially free of effects of package expansion and saturation of container walls;

displacing any air or unwanted gases from the first cell with a carrier gas different from the test substance;

filling the space in the first cell with the carrier gas so that the carrier gas contacts the at least one container and mixes with any of the test substance that permeates from the at least one container to form a gas mixture comprising the carrier gas and an amount of permeated test substance and displacing any air and unwanted gases from the first cell;

holding the at least one container and the carrier gas in the first cell for at least a period of time sufficient for measurable permeation of the test substance out of the at least one container to occur;

thereafter, analysing the gas mixture to determine the amount of permeated test substance; and

determining the permeation rate of the test substance out of the at least one container based on analysis of the gas mixture.

According to still another preferred embodiment, a method for measuring the gas permeation and shelf-life characteristics of at least one container having an opening, the method comprising the steps of:

placing the at least one container inside a first cell so that the at least one container is fixed and sealed to the first cell so as to seal an interior of the container from a space inside the first cell between the first cell and the at least one container;

closing the first cell;

filing the at least one container with a carrier gas different from the test substance and displacing any air and unwanted gases from the at least one container;

filling the space in the first cell with a test substance and displacing any air and unwanted gases from the first cell;

stabilizing the at least one container so that the test substance permeates at a permeation rate through the at least one container and the permeation rate of the test substance through the at least one container is substantially free of effects of package expansion and saturation of container walls;

displacing from the at least one container with the carrier gas any test substance that entered the at least one container during the step of stabilizing;

holding the at least one container in the first cell and the carrier gas in the at least one container for at least a period of time sufficient for measurable permeation of the test substance into the at least one container to occur at a permeation rate and form a gas mixture comprising the carrier gas and an amount of permeated test substance;

thereafter, analysing the gas mixture to determine the amount of permeated test substance; and

determining the permeation rate of the test substance into the first container based on analysis of the gas mixture.

Other features of preferred embodiments of this invention will be appreciated from the following detailed description of embodiments and claims.

### BRIEF DESCRIPTION OF DRAWINGS

FIG. 1 is a schematic representation of one embodiment of this invention, for measuring the permeation out of a package, which is pre-filled with a test substance.

FIG. 2 is a graphical presentation illustrating how results from measurements made using the embodiment in FIG. 1 may be analyzed to give permeation rate and barrier improvement in relation to a reference package.

FIG. 3 is a graphical presentation illustrating how supplementary data, which is needed together with permeation rate to calculate shelf-life, may be obtained.

FIG. 4 is a schematic illustrating another embodiment of this invention for measuring permeation of a package that can be filled within the permeation-measuring equipment.

FIG. 5 is a schematic illustrating still another embodiment of this invention for measuring permeation into a package.

FIG. 6 is a schematic illustrating another embodiment of this invention for measuring permeation of a flat film. This embodiment can be used in conjunction with the methods and equipment described for packages.

FIG. 7 is a schematic illustrating a preferred embodiment of this invention for rapid measurement of multiple package samples, giving permeation rate, barrier improvement against a reference and shelf-life, for a wide range of package sizes, without need to change the basic equipment.

FIG. 8 is a schematic of an extension to the apparatus in FIG. 7, to avoid ingress of atmospheric gases into the circuit of the measuring system.

### DETAILED DESCRIPTION OF EMBODIMENTS

FIG. 1 illustrates one embodiment of the present invention for measuring the permeation rate of gas through a sealed package 10 comprising a container 12 sealed with a closure 14, or alternatively, without a closure such as with a package that is a sealed pouch. The container is filled with a test substance 16 for testing. The test substance 16 can be a composition for storage in the package, such as a carbonated or non-carbonated beverage or other test substance, or simply a test gas by itself, or a composition that includes a test gas as a component of a more complex mixture such as a beverage. The test gas is a gas or mixture of gases that permeates the package 10 and can be any permeating gas or mixture of gases. For example, the test gas can be a component of a more complex composition such as carbon dioxide in a carbonated beverage, a single gas such as carbon dioxide, oxygen, water vapor or another gas, a gas mixture including combinations of carbon dioxide, oxygen, and water vapor and the like, a gas such as oxygen whose entrance into the package can contaminate or spoil the content of the package, or alternatively a test-gas such as helium or water vapor or the like whose permeation characteristics can be related to the characteristics of shelf-life determining permeating gases. In the latter example, the test gas simulates another gas or composition. Such a simulating test gas has a permeation rate indicative of the shelf-life of a test substance that may include the simulating test gas or may not include the simulating test gas at all.

The package 10 is disposed in a permeation testing device 18 comprising a cell 20 fitted with a purge gas inlet 22 and purge gas outlet 24. Optionally, an internal displacer 26 may be disposed in the cell 20 for reducing the amount of space between the package 10 and the cell 20. The permeation testing device is also fitted with a gas measurement device 28 for analysing the gas content.

The container 12 can formed of any material but is preferably a plastic container. The permeation testing device 18 and the other embodiments disclosed herein are particularly suited for testing PET bottles. Most preferable, the embodiments of this invention are useful for testing beverages such as carbonated beverages packaged in PET bottles.

In operation, the permeation tester 18 in FIG. 1 tests the permeation rate of the package 10 when the package is filled with the permeating test substance 16. After filling, the package container 12 is closed and sealed by closure 14 such as a cap. The test substance 16, when gaseous, can be filled into the package container 12 by weighing a predetermined quantity of the test substance in its solidified or liquid form (at low temperature), which then forms a gas after closing, when temperature rises to ambient. For example, in case of carbon dioxide, a quantity of dry ice can be weighed into the package container 12 and later allowed to form a gas after the closure 14 has been applied. When measuring the permeation of a gas from the inside of package 10 to the outside, it is important to purge the inside of package container 12 with the same gas, such as carbon dioxide, to ensure that air or other gases in the package can be displaced and expelled.

The package 10 is placed in the cell 20, which can be opened to admit the package 10 and re-closed. The opening/re-closing and sealing features of cell 20 are conventional and not shown. A gas-space 30, between the outside of the package 10 and the inside of cell 20, is filled with a carrier gas, which is normally inert and different than the test substance 16. For example, when the test substance 16 is carbon dioxide, the gas-space 30 is usually filled with nitrogen. It is important to ensure that no traces of the test substance 16 are present in the gas-space 30 before testing begins, and this is achieved by purging the gas-space 30, using the inert carrier gas chosen to fill the gas-space 30, so as to displace all detectable traces of air or other gases. The purge gas inlet 22 and outlet 24 are used for purging. In certain cases, the cell 20 can be fitted with the internal displacer 26, so as to minimize the volume of the gas-space 30 and enhance the sensitivity of measurement of permeation into the gas-space 30. However, the internal displacer 26 is not normally needed when sensitive gas-measurement equipment is used.

The gas measurement-device 28 connected to the cell 20 can detect and quantify the test substance 16. The measurement-device 28 can use any state-of-art method that measures the quantity of the test substance 16 permeating into the gas-space 30. The simplest of such measurement methods is a pressure gauge, but this is non-specific to the gas species of the test substance 16, and therefore only applicable when a single, pure test substance is used. When more than one gas species can permeate into the gas-space 30, whether the presence of more than one gas is intentional, such as when the test substance 16 is a gas mixture, or unintentional, such as when other gases are naturally dissolved in the walls of package container 12, a measurement device 28, or a plurality of devices in case of several gases, must be used, whose method is specific to the gas or gases measured.

A state-of-art measurement method, which is specific to many gas species, is IR absorption, and this can analyse the quantity of each of several gas species in a gas mixture. Other state-of-art methods, whose application depends on gas species, include UV-absorption, conductivity/resistivity or paramagnetism probes, flame ionisation devices, or mass spectroscopes. The measurement method used for the measurement device 28 will depend on the test substance 16. When the test substance 16 is carbon dioxide, or water, or mixture of both, the measurement of IR absorption, using the FTIR method (Fourier Transform IR=FTIR) is effective. For oxygen, a surface-active resistance probe (eg lambda probe) can be used. Where the measurement method for the measurement device 28 is complex/expensive, it is often advantageous to locate the measurement device in an external circuit, rather than mount it directly onto the cell 20 (as described below).

To test the package 10, the package container 12 is filled with a predetermined quantity of the test substance 16, then closed and sealed. The package 10 is inserted into the cell 20 and the lid of cell 20 (not shown), which is necessarily opened to admit the package 10, is closed to commence testing. Normally, the test substance 16 will be absorbed to some degree within the walls of the package container 12, and it is therefore necessary to delay insertion into the cell 20 until the walls of the container have been saturated with the test substance 16 (as described in further detail below). After inserting the package 10 in the cell 20 and closing/sealing the cell, the gas-space 30 is purged with a suitable gas, such as nitrogen, so as to remove all traces of the test substance 16 in the gas-space 30. When this purging is complete and the purge-connections 22 and 24 are closed, the concentration of the test substance 16 in the gas-space 30 begins to rise, due to permeation of the test substance into the gas-space. The test method consists basically of measuring the total amount of the test substance 16, which permeates into the gas-space 30 over a pre-determined period of time. Because the purge connections 22 and 24 are closed, during permeation measurement, the permeation tester 18 is a closed system and the permeated test substance is allowed to accumulate in the gas-space 30 while the amount of inert carrier gas in the gas-space remains constant.

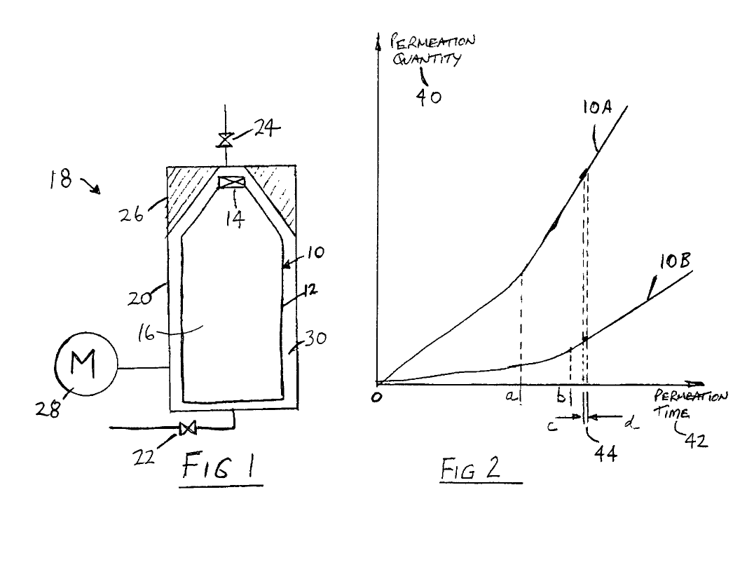

FIGS. 2 and 3 show in principle how the permeation test results may be analyzed. FIG. 2 shows a typical change of permeation-quantity 40 (as would be measured outside the package 10 over the total time shown) against the permeation-time 42. The change in permeation-quantity 40 is shown both for a reference-package 10A and for a test-package 10B, and applies particularly to the permeation of a gas such as carbon dioxide out of a PET-bottle, where the gas absorbs significantly in the bottle walls and where the said walls can also expand under pressure. Permeation-quantity increases slowly until the walls of the package 10 have been saturated by the test substance 16 and, where the package is under internal pressure, also until the expansion of the walls of package has virtually ended.

Time-point a, for reference-package 10A, and time-point b, for test-package 10B, indicate the time-point when said wall-absorption and wall-expansion effects are approximately ended and the permeation rate of the test substance out of the package can be measured free of these effects. These are points of maximum absorption of the test substance in the walls of the container (or saturation of the container walls with the test substance) and maximum volumetric expansion of the container 12. After said time-point a and b, a true measure of permeation-rate (PR) can be obtained by measuring the increase in permeation-quantity 40 with permeation-time 42, free of package-expansion and wall-absorption effects. Since the time-elapse denoted by 0-a and 0-b in FIG. 2 is very much greater than the time needed to measure PR, one advantage of the present invention is the ability to store the package 10, after filling, outside the measuring system, for example, in a conventional pre-conditioning cabinet (not shown), and to insert the package 10 in the cell 20 only after time-points a or b. This increases the capacity of the permeation tester 18, because it eliminates waiting time. A further advantage is that the said conventional pre-conditioning cabinet can be both temperature and humidity-controlled, so that the subsequent permeation-measurement in permeation tester 18 can more closely approximate to real market conditions.

The absolute PR (ie PR measured in terms of volume or weight per unit time) out of the package 10 is highest when the package is full of the test substance 16, and gradually reduces as the quantity of said test substance in the package drops due to permeation-loss. This is because the driving-force for permeation out of the package 10 reduces as the quantity of test substance 16 in the package is reduced. Therefore the lines of permeation-quantity 40 versus permeation-time 42 in FIG. 2 are approximately linear, and normally, significant signs of non-linearity appear only after a period of at least days, usually weeks, depending on the material of the package 10 and the type of test substance 16.

In the present invention, measurement of permeation-quantity 40 takes place over a measurement-time 44, which ranges from less than 5 minutes to less than 3 hours, depending on the material of the package 10 and the type of test substance 16. During this measurement time, the package 10 is held in the cell 20 for at least a period of time sufficient for measurable permeation of the test substance out of the package to occur. During such a relatively short measurement-time 44, the lines of permeation-quantity 40 versus permeation-time 42 are linear in practical terms. Therefore, just 2 measurement points are needed, one at the start of measurement-time 44 and one at the end of said measurement-time, as denoted by time-points c and d respectively in FIG. 2. The change in permeation-quantity 40 measured over measurement-time 44 gives the absolute PR at a time-point that is mid-way between time-points c and d.

Although absolute PR out of the package 10 varies with permeation-time 42, as the quantity of test substance 16 in the package is reduced, the relative PR (ie the permeation rate expressed as a proportion of any quantity of test substance 16 in the package) stays constant. For the reasons explained hereinbefore, the measurement-time 44 must be after time-points a and b for packages 10A and 10B respectively. It is convenient to measure packages 10A and 10B, both at same time and at a time-point, which is safely past time-points a and b. It is then necessary to correct the absolute PR measured, so that it can be expressed in terms of the known initial quantity of the test substance 16 in the package 10 at time-point 0, or so that it can be expressed in terms of relative PR.

The absolute PR actually measured between time-points c and d (when the permeation-quantity in the package 10 is unknown and less than said quantity known to have been filled at time-point 0) can be used to calculate the absolute PR at time-point 0, or the relative PR, which is constant for all time-points. The permeation characteristic (ie the relative PR) is a constant function of the material of the package 10, and can be regarded as a fixed, constant resistance to permeation. The actual PR at any time-point varies only because of the varying driving force through said fixed resistance, which is equal to the quantity of test substance 16 in the package 10, assuming that the quantity of the test substance outside the package is relatively negligible.

Therefore, it can be shown mathematically that:

Pₜ=P₀.e^{-ct}

Where:

Pₜ=vapour pressure or quantity of test substance 16 at any time-point t.

P₀=vapour pressure or quantity of test substance 16 at time-point 0.

c=PR (permeation rate, expressed as proportion of test substance lost per unit time)=a constant.

t=time (eg in days) since filling a known quantity of test substance 16 into the package 10.

With this relationship, a measurement reasonably close to time-point a or b can be referred to time-point 0, when the quantity of test substance 16 in the package 10 was known. This enables PR to be measured with the main and preferred principles of the present invention, which are demonstrated by FIG. 1. In summary, said principles apply to permeation of the test substance 16 out of the package 10, whereby the test substance either exerts a vapour pressure above atmospheric (preferable, because this gives most rapid results), or is at atmospheric pressure, and also whereby in-bottle-wall absorption of the test substance, as well as bottle-wall expansion are factors to be considered. In particular embodiments, this applies to carbonated or still beverages packed in PET-bottles, where, even for still beverages, a certain internal vapour pressure from an inert gas is always needed to give bottle stiffness. Although in practice, oxygen permeates into, rather than out of a package, it is convenient and valid to measure all permeations, including oxygen, from inside the package 10 to outside. Where wall-expansion of the package 10, or in-wall absorption of the test substance 16, as hereinbefore described, do not apply, the same measurement and calculation principles continue to be valid, but are simplified by the elimination of these effects.

The time-elapse to time-points a and b is the time needed to stabilize the package 10 with respect to secondary factors, such as in-wall absorption and wall-expansion, which influence the permeation measurement outside the package and prevent measurement of the PR of the material package. This said stabilization-time will be denoted ST hereinafter. The ratio calculated by dividing measured PR for the reference-package 10A with measured PR for the test-package 10B represents the improvement in permeation-resistance of the test-package 10B compared with the reference-package 10A. This ratio is often referred to as the “barrier improvement factor” (BIF), and is of critical interest when assessing the effectiveness of different barrier treatments for the package 10.

For measuring PR or BIF on a repetitive basis and for many samples, ST must first be measured for both the reference-package 10A and the representative test-package 10B. The PR of the package 10 is a major factor affecting ST, and ST is high when the package 10 has a high BIF, low when the package 10 has a low BIF. However, in practice, ST is relatively short and varies only to a limited extent between the highest and lowest BIF characteristics of the package 10. Therefore, ST need only be measured once for the reference-package 10A and once for the test-package 10B, and the starting time-point for all subsequent measurements of BIF can be chosen such as to provide a reasonable margin, so as to be sure that both said packages are well past their ST (ie after allowing for a “safe” ST, which takes into account the whole range of potential differences in BIF).

In order to calculate shelf-life with respect to the test substance 16, the hereinbefore described effects on permeation-quantity 40 of in-wall absorption of the test substance 16 and wall-expansion of the package 10 must be separately measured for a given basic package design. In practice, these said effects are influenced by the weight, shape, wall-thickness and other dimensions of the package 10, and the influence of said effects is therefore constant, when—for example—repetitive samples of same design of the package 10, with different barrier treatments must be measured. Therefore, for a given package design, the said effects can be evaluated on a one-time basis and used to calculate shelf life for different barrier-treated versions of the package 10, as follows:

maximum allowable loss, expressed as fraction
of initial amount of test substance 16 inside
the package 10, from standpoint of acceptable
shelf-life = q
fraction of initial amount of test substance 16
lost from inside of the package 10, during ST due to
package-wall expansion and in-wall absorption = y
net fraction of initial amount of
test substance 16 which can be lost by
permeation to outside the package 10 from
standpoint of acceptable shelf-life = q − y = z
measured permeation PR, expressed
as fraction per day of quantity of the test-
substance 16 in the package 10 at given time-point = p/week
shelf-life with respect to test substance 16 = n days

It can then be shown that:

n=log(z+1)/log(p+1)

FIG. 3 shows in principle how the fraction y of the initial amount of the test substance 16, which is lost from inside of the package 10 during ST due to package-wall expansion and in-wall absorption, can be measured for a given package design. The other factors in the above equation, giving n, are already known, because z is a function of y and the permissible fraction q (from quality standpoint) and p is equal to PR, as measured with the principles described hereinbefore.

In FIG. 3, the variation of in-package quantity-fraction 46 is shown against permeation time 42. The quantity-fraction 46 is the quantity of test substance 16 in the package 10 expressed as fraction, where the starting quantity=1. The quantity-fraction 46 can be measured by simple means, for example by installing a pressure-gauge on the package 10 after filling and measuring the quantity-fraction until the ST has been exceeded sufficiently to measure the slope 48. When the slope 48 is extrapolated to time-point 0, an intercept 50 is obtained. The quantity-fraction 46 at time-point 0 is the start-fraction 18 (=1). The intercept 50 represents the “start-fraction”, which would have applied, if the effects needing ST were not present. Therefore, the quantity-fraction y, due the effects needing ST, is the quantity-fraction denoted y in FIG. 3.

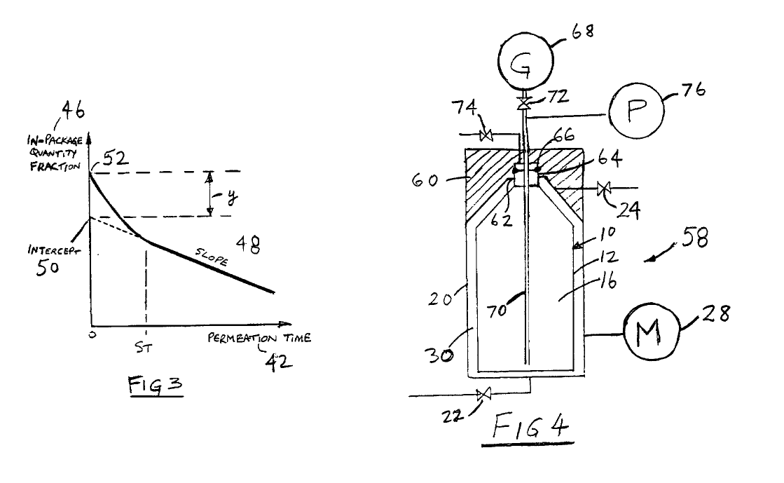

FIG. 4 illustrates a permeation tester 58 that is a modification of the tester 18 shown in principle in FIG. 1. The modified permeation tester 58 comprises a cell 20 including a headpiece 60 at the upper portion of the cell. The headpiece 60 has a fixture 62 for receiving the container 12 of the package 10. Particularly, the package container 12 has a mouth 64 defining the opening of the container and the fixture 62 of the headpiece 60 receives the mouth of the container. The mouth 64 of the container 12 is sealed to the fixture 62 by an O-ring 66 disposed in the fixture. The container 12 is fixed and sealed to the cell 20 so as to seal an interior of the container from the space 30 inside the cell between the cell and the container.

An external regulated gas supply 68 feeds gas into the container 12 through a dip tube 70 extending through the headpiece 60 of the cell 20 and the mouth 64 of the container 12. A gas supply valve 72 controls the supply of gas from the external regulated gas supply 68 to the interior of the container 12. The headpiece of the cell 20 is fitted with a purge 74 for purging gas from the interior of the container 12. A pressure gauge 76 monitors pressure of gas fed into the container 12 by the external regulated gas supply 68.

In operation of the modified permeation measuring system 58, the package 10 can be filled with a gaseous test substance 16 after being inserted in the cell 20 with the external regulated gas supply 68, whereas in FIG. 1, the package is placed in the cell after filling. Filling of the package 10 within the cell 20 is achieved by fixing the container mouth 64 into the fixture 62 in the head-piece 60 of the cell, and then sealing the mouth with the O-ring 66 or a similar sealing device. The gas-supply 68, containing test substance 16, is piped by the dip-tube 70 to base of the container 12. The purge 74 is provided at top of the package 10, and purging of air from inside the container is carried out by allowing gas from the gas supply 68 to flow down the dip-tube 70 and flow out of purge, thus displacing air in the package 10. After purging the inside of the container 12 has been completed, the gas supply valve 72 and purge 74 are shut off, and the gas-space 30 between the cell 20 and the package 10 is purged to displace air in the manner already described under FIG. 1. When purging of the gas space 30 has been completed, measurement of permeation characteristics (PR and BIF and shelf-life) can proceed as already outlined.

The system shown in FIG. 4 can be advantageous, because it enables the test substance 16 to be kept at constant pressure, as monitored by the pressure gauge 76, for the entire measuring cycle. This constant gas-pressure compensates for permeation losses from the inside of the package 10, and maintains a constant driving force for permeation. The pressure inside the package can be greater than atmospheric pressure. This constant-pressure mode can be advantageous for certain measurements, since PR remains constant even over extended periods, when the driving force for permeation is constant. When operating in this said mode, the gas supply 68 is fitted with a conventional pressure-regulator and the valve 72 remains open throughout the measurement period.

The disadvantage of this embodiment is that the package 10 must remain connected to the permeation measuring system 58 throughout the period of ST. This reduces the measurement output of the modified measurement system 58 compared with the possible output of a system based on FIG. 1, where the package 10 does not need to be connected to the measuring system until ST is complete. The said disadvantage becomes unimportant for package/test substance combinations with very short or negligible ST.

FIG. 5 illustrates a further modified permeation measuring system 80 using the principles described hereinbefore for measuring permeation characteristics (PR, BIF, shelf-life) when the test substance 16 permeates into the package 10, whereas the systems described hereinbefore provide means for measuring said permeation characteristics when the test substance 16 permeates out of the package 10.

The further modified permeation measurement system 80 has a similar structure to the permeation measurement system 58 illustrated in FIG. 4 and like reference numerals indicate like components in the Figures. In the further modified permeation measurement system 80, a second gas supply 82 is connected to the cell 20 for delivering a gaseous test substance 16 to the gas space 30 between the cell 20 and the container 12. A second valve 84 regulates the flow of the gaseous test substance 16 from the second gas supply 82 to the gas space 30. In addition, a second gas measurement device 86 is fitted to the cell 20 for monitoring the gas in the gas space 30 between the cell 20 and the container 12. This enables use of a second test substance 16a from the first gas supply 68.

In operation of the embodiment 80 illustrated in FIG. 5, the package 10 is filled with an inert carrier gas from the first gas-supply 68, in the same basic manner as already described for FIG. 4, via the dip-tube 70 and using the purge 74. The inert carrier gas-supply valve 72 is shut off when air has been purged out of the interior of the package container 12.

The second gas supply 82 contains the test substance 16, and therefore, in contrast to the method described in FIG. 1, the test substance 16 is placed in the gas-space 30 between the cell 20 and the container 12 and permeates into the package 10 from outside. Using the second gas-supply 82, the gas-space 30 is purged via the outlet purge 24 so as to displace all traces of air from the gas-space and thus fill the gas-space entirely with the test substance 16. Thereafter, either the stop-valve 84 remains open and a constant pressure from the second gas-supply 82 is maintained in the gas-space 30, or the stop-valve is closed, where the change in pressure during permeation has a negligible effect on the measurement accuracy. The first gas measurement device 28 is used to measure the quantity of gas permeating into the package 10, and permeation characteristics are measured by applying the same principles as described already in conjunction with FIG. 1.

If permeation of air into the package 10 under atmospheric pressure is to be measured, the base section of the cell can either be provided with apertures for air ingress, or eliminated altogether. However, higher-than-atmospheric pressure of the test substance 16 enables faster achievement of permeation results, and the cell also has the advantage of enabling use of oxygen and other gases, rather than air. If higher-than-atmospheric pressure of the test substance 16 is applied to the gas-space 30, this must normally be balanced by an equal or greater pressure of inert carrier gas from the first gas-supply 68 inside the package 10.

In FIG. 5, it is possible to fit the second gas measurement device 86, which monitors the gas analysis in the gas-space 30. This enables use of a second test substance 16a from the first gas-supply 68 instead of an inert carrier gas, so as to measure permeation into, and out of, the package 10 simultaneously. For example, the first test substance 16 could be oxygen or air whilst the second test substance 16a could be carbon dioxide. In common with the principle of the embodiment in FIG. 4, the principle of the embodiment in FIG. 5 requires that the package 10 is connected to the equipment during ST, which the principle of FIG. 1 avoids.

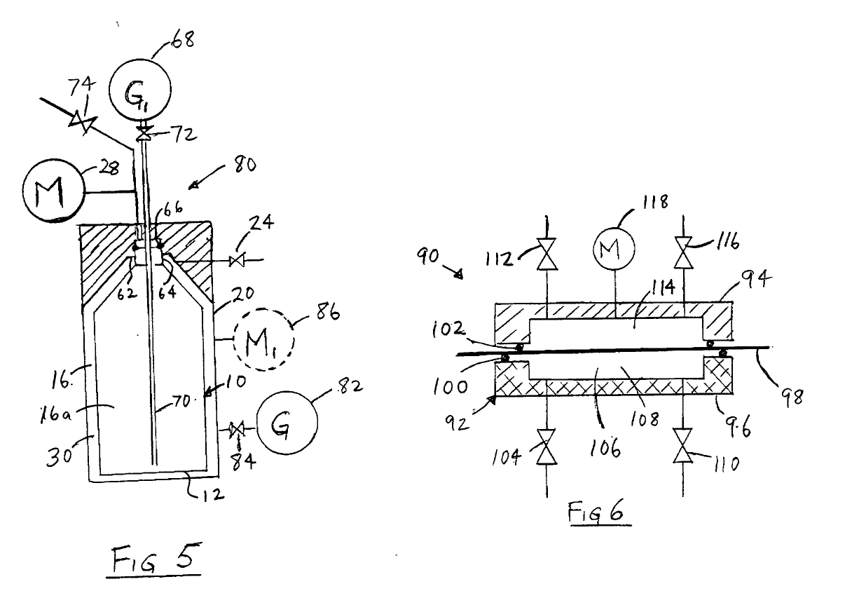

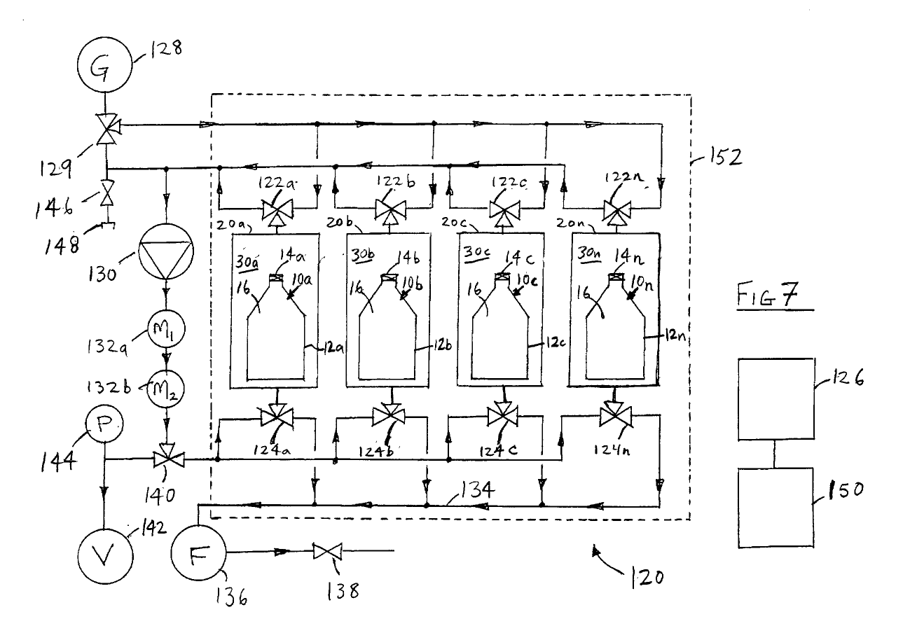

FIG. 6 illustrates a permeation measurement system 90 that applies the measurement principles of the embodiments illustrated in FIGS. 1, 4 and 5 when research work necessitates testing of a film or package wall, or other sheet like material, rather than complete packages. This embodiment 90 comprises a cell 92 including a top section 94 juxtaposed with a base section 96. A test sample sheet 98 is disposed between the top section 94 and the base section 96 and sealed to the cell with O-rings 100 and 102 at each end of the cell 92.

A first gas inlet 104 feeds a gaseous test substance 106 into a first compartment 108 between the base section 96 and the test sample sheet 98. A first gas outlet 110 allows purging of the first compartment 108.

A second gas inlet 112 feeds inert carrier gas into a second compartment 114 formed between the top section 94 of the cell 92 and the test sample sheet 98. A second gas outlet 116 provides for purging of the second compartment 114.

A gas permeation measurement device 118 is operatively associated with the second compartment 114 for measuring the PR of the test substance 106.

In operation of the permeation measurement system 90 in FIG. 6, the flat test-sample 98 is clamped in the cell 92 between the top section 94 and the base section 96. Both sides of the test-sample 98 are sealed by the o-rings 100 and 102. The first gas inlet 104 and first gas outlet 110 enable air-purging and filling of the first compartment 108 with the test substance 106 (as hereinbefore described for a package in FIG. 5), whilst the second gas inlet 112 and second gas outlet 116 enable air-purging and filling of an inert carrier gas (as hereinbefore described for a package in FIG. 1) in the second compartment (or gas-space) 114. The permeation measurement-device 118 then measures the PR of the test substance 106, also as already described. Similar devices for flat film exist, but the system 90 in FIG. 6 can be used with the package-testing methods described with regard to the embodiments in FIGS. 1, 4 and 5. This increases the flexibility of said systems, when applied to research and development.

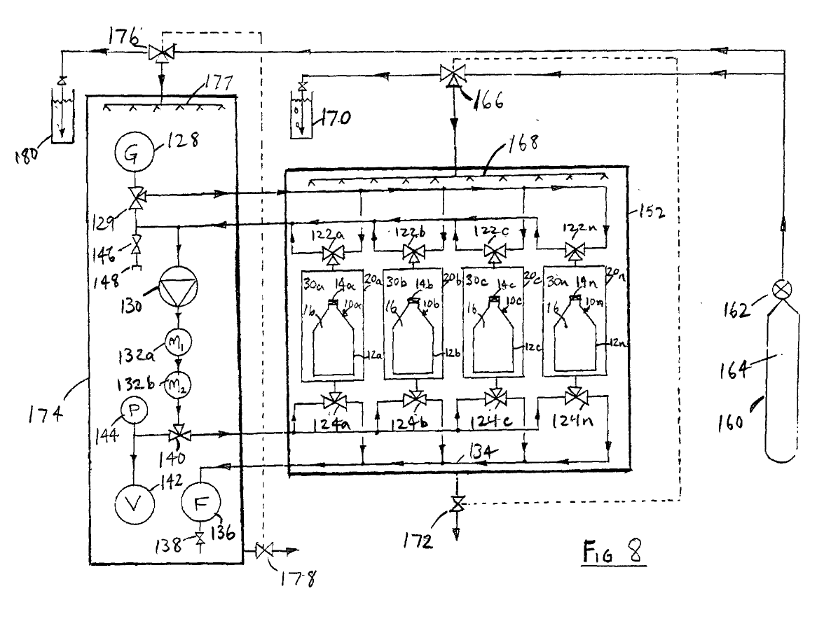

Cell 92 can also be treated similarly to package 10 by being placed in the cell 20 of the embodiment 18 FIG. 1 or the embodiment 120 in FIG. 7. In this case, a large aperture (not shown) is inserted in the top section 94 of cell 92, in place of the permeation measurement-device 118, the second gas inlet 112 and the second gas outlet 116. The top section 94 and the base section 96 form a flat film holder defining a holding space for the test substance on one side of the flat film and the open aperture defines a free surface on another side of the flat film so that the flat film holder can be placed in the first cell and the test substance can permeate from the holding space, through the flat film, and into the carrier gas in the first cell 20. This leaves the surface of test sample 98 of flat film free to be measured as already described for the surface of the container 10. This option constitutes a significant simplification in procedure, especially in conjunction with the embodiment of FIG. 7.

FIG. 7 shows a system 120 based on the principles of the embodiment 18 shown in FIG. 1. Each of a multiplicity of packages 10a, 10b, 10c . . . . to 10n are placed in cells 20a, 20b, 20c . . . to 20n, so that each package is in its own individual cell. Where differentiating between the permeation characteristics of individual packages 10a-10n is unnecessary, it is also possible that each of the cells 20a-20n holds a multiplicity of packages. When only one package 10 is to be measured in each cell 20, the number of cells would normally be at least 12, possibly far more, but for the sake of simple presentation, only 4 are shown in FIG. 7. Each of the packages 10a-10n contains the test substance 16, as described above in conjunction with FIG. 1.

Each of the cells 20a-20n has a top-valve 122a-n mounted near top of the respective cell and a base-valve 124a-n mounted near the base of the respective cell. It is normally expected that each top-valve 122a-n and each base-valve 124a-n will be most conveniently connected to the sidewall of the respective cell 20a-n, with each top-valve 122a-n close to the top of the respective cell, and each base-valve 124a-n close to the base of the respective cell. Connection of each top-valve 122a-n and each base-valve 124a-n to the sidewall of respective cells is a practical measure, because it leaves the top of the cells free for a quick-release lid, enabling easy access for inserting and removing packages 10, and also leaves the base free for mounting the cells onto a back-plate. In FIG. 7, for the sake of simplicity of presentation, the top-valves 122a-n and base-valves 124a-n are shown mounted on the lid and base of the cells 20a-n respectively, since this does not affect the principles described herein. The top-valves 122a-n and base-valves 124a-n can be conventional 3-way devices (as shown), or consist of a system of more than 1 valve, when this fulfils the operations described hereunder. The top-valves 122a-n and base-valves 124a-n are conventionally motorized and controlled by a sequence-controller 126 (eg remote-controlled, solenoid-operated valves).

A regulated gas-supply 128, supplying an inert carrier gas such as nitrogen, is connected via a gas-valve 129 to each top-valve 122a-n and to a pump 130. Each top-valve 122a-n is also connected to the pump 130, and the pump leads to one, or a multiplicity of gas measurement-devices 132a, 132b, etc. The measurement-devices 132a, 132b, etc, can detect and measure the quantity of each component of the test substance 16. The test substance 16 can be a single gas (eg carbon dioxide) or a mixture of gases (eg carbon dioxide, oxygen, water), depending on the permeation and shelf-life data needed. The reason for using more than 1 measuring device 132a, 132b is to cover the range of components of the test substance 16. For example, an FTIR (Fourier Transform Infra-Red) device can measure the quantity of carbon dioxide and water simultaneously, but a different device is needed to measure the quantity of oxygen, if this is also needed.

The measurement-devices 132a, 132b, etc, are connected to the base-valves 124a-n so as to form a circuit around each cell 20a-n. The pump 130 is preferably a metal bellows pump, or similar, so as to avoid possibility either of leaks or of absorption of gases in the pump's seal or other contact parts.

The base-valves 124a-n are connected via an exhaust-manifold 134 to an exhaust-gas flow-meter 136 which is connected to a control valve. A purge-valve 140 is connected to a vacuum-pump 142 for evacuating the gas content of each measurement-circuit, which consists of the pipe-work from each top-valve 122a-n, through the pump 130 and measurement devices 132a-b to each container base-valve 124a-n and will be denoted MC. The pressure gain (if any) in the total-test-circuit, over a pre-determined time, is monitored by a pressure-gauge 144.

A calibration valve 146 in communication with the measurement devices 132a-b via the pump 130 is connected to a coupling point 148. A known-quantity injection-device (eg syringe) can be connected to the coupling point 148 and a calibration amount of each component can be injected by opening the calibration-valve 146.

A computer 150 regulates the operation of the measurement-devices 132a and 132b, registers the permeation quantities of each component of test substance 16 from each cell 20, and monitors correct circuit-purging.

The cells 20a-n are located in a conditioning cabinet 152. This cabinet 152 has a temperature-controlled interior, since ambient temperature affects permeation. The means of controlling temperature in the cabinet 152 are state-of-art and will not be discussed further.

In operation of the embodiment 120 shown in FIG. 7, packages 10a-n are placed in the respective cells 20a-n and the regulated gas-supply 128 supplies a stream of inert carrier gas via the gas-valve 129 and via top-valves 122a-n to each of the cells 20a-n to purge/displace air out of the gas-spaces 30a-n of said containers by exhausting the air, mixed with inert carrier gas, through the exhaust-manifold 134 and flow-meter 136 to the atmosphere. The purpose of said purging/displacement is to eliminate all significant traces of air in gas-spaces 30a-n and to replace the air with the inert carrier gas from the gas-supply 128. The flow-meter 136 enables the flow of displaced gas to be controlled by the control-valve 138, so as to secure effective purging/displacement within a pre-set time-elapse. The sequence-controller 126 controls the purging operation such that each of the cells 20a-n in turn is purged free of air in a predetermined time.

The purging of the gas-spaces 30a-n takes a finite time, and this is repeated for the gas-spaces of each cell 20a-n in turn. By the time the purge-sequence of all cells 20a-n has been completed, the first cell to have completed its purge-cycle has had sufficient time to collect adequate quantities of each component of test substance 16 to enable measurement-devices 132a-n to measure the quantity of each said component of test substance 16 that has permeated into the gas-spaces 30a-n. One factor, which determines the number of cells 20a-n in the total system, is the desire to match total purging-time of all cells to the time needed to begin measurement of the first-purged cell.

Before measurement of the quantity of each component of test substance 16 can begin, each measurement-circuit, which consists of the pipe-work from each top-valve 122a-n, through the pump 45 and measurement devices 132a-b to each container base-valve 124a-n must be purged completely free of air traces and traces of the gases from the last measurement cycle. This is carried out by opening the purge-valve 140, which is connected to vacuum-pump 142, and evacuating the gas content of said MC. Then purge-valve 140 is closed and the gas-valve 129 is opened, filling the said MCs with inert carrier gas from the gas-supply 128. The cycle of evacuation/refilling of said MC may need to be repeated 2 or more times, till all traces of gas, other than the inert carrier gas from gas-supply 128, have been expelled. This evacuation and inert carrier gas refilling of the MCs is denoted “circuit-purging” and is repeated before measuring permeation into the gas-space 30 for each cell 20a-n. The adequacy of circuit-purging is monitored by measurement-device 132a-n, which should read virtually zero after adequate circuit-purging.

The computer 150 regulates the operation of measurement-devices 132a-b, registers the permeation quantities of each component of test substance 16 from each cell 20a-n and monitors correct circuit-purging. The sequence-controller 126 controls the operation of all valves shown in FIG. 7 (ie top-valves 122a-n, base-valves 124a-n, gas-valve 129, exhaust-valve 138 and purge-valve 140), as also the operation of pump 130, flow-meter 136 (and purge control via exhaust-valve 138) and vacuum pump 142. The sequence-controller 126 regulates the time-elapse between completion of purging (ie start of permeation) and final measurement of permeated quantities, and said time-elapse is relayed to the computer 150, enabling the computer to calculate PR, BIF and shelf-life, using the basic pre-set data and procedure described in conjunction with FIGS. 2 and 3.

The package 10 must be prepared before placing in a cell 20a-n by filling and pre-conditioning. Pre-conditioning involves storing the package 10 at same temperature as the cabinet 152 until ST has been reached or exceeded. Pre-conditioning involves keeping the package 10 in a pre-conditioner (not shown), which is a chamber with similarly controlled temperature as the cabinet 152. It is desirable that pre-conditioning is in a humidity-controlled environment, because humidity, as well as temperature, can affect permeation. Pre-conditioning chambers with humidity and temperature control are commercially available. The capacity of a pre-conditioning chamber must allow for sufficient packages to be stored for the duration of ST, so as to supply the daily rate of testing by the system 120.

Filling the package 10 can be optionally with a gas (eg carbon dioxide in a PET package), or a gas mixture (eg carbon dioxide, oxygen and water). The internal pressure of the package 10 during testing should normally reflect the internal pressure of the said package during market distribution at the test temperature. However, since the measurement system 120 can measure permeation characteristics (PR, BIF, shelf-life) at varying conditions, it is also possible to test at higher internal pressure in the package 10 for all or some of the components of the test substance 16, and relate this to normal market conditions, whilst benefiting from the accelerated testing provided by higher internal pressures.

As partly described above, the filling procedure with gas can be by weighing into the package 10 the cooled solid or liquid form of the gas (eg dry ice for carbon dioxide), or by weighing reacting chemicals (eg oxygen generating chemicals). Alternatively, a stoichiometrically-prepared aqueous mixture of the test substance (eg carbonated water) can be used. Into the carbonated water, weighed-out oxygen-generating chemicals can be added, enabling the permeation characteristics of carbon dioxide, oxygen and water to be measured simultaneously. Mixtures of gas can also be filled into the package 10 by means of a tank (not shown), in which a plurality of packages 10 are placed. Known partial pressures of each test gas are filled into the tank, and the tank is provided with means of sealing the package 10 by applying a closure 3 without releasing pressure. This tank system can be built according to the above description by state-of-art means and will not be described any further.

In all cases, the quantity of each component of test substance 16, which is filled into the package 10, must be known with reasonable accuracy, because the measured PR relates to this starting quantity. The measurement system 120 can also be used to measure permeation characteristics (ie PR, BIF, shelf-life) of the package 10, when this is taken direct from the test substanceion line (eg PET bottles from a carbonated beverage filling line), non-invasively.

Since leaks in the measurement system 120 can be a source of error, a self-checking facility, which can automatically be applied periodically (eg daily before testing begins), is included. Under the automatic control of the sequence-controller 126, the entire circuit system, consisting of MCs, cells 20a-n, and all associated interconnecting pipes (“total-test-circuit”), is placed under vacuum by opening the purge-valve 140 to communicate with the vacuum pump 142. The purge-valve 140 is then closed, and the pressure gain (if any) in the total-test-circuit, over a pre-determined time, is monitored by pressure-gauge 144. If a pressure-gain is detected, the sequence-controller 126 then proceeds to close off each cell 20a-n in turn, whilst repeating the procedure of evacuation and monitoring of pressure-gain, until the specific circuit, which has the leak, has been identified. In addition to leak-testing, the function of measurement-devices 132a-b is checked for every measurement batch by keeping one of the cells 20a-n empty and using the said measurement-devices to check whether the correct zero-point, based on measuring the empty cell, is maintained.

If a fault is detected, either due to a leak or due to a faulty-reading measurement-device 132a-b, the computer 150 informs the operator automatically. Operator involvement is reduced to loading filled test-samples of packages 10 into cells a-n, closing the lid of the cells and pressing the “start button” on the sequence-controller 126, whereupon the system goes through its checks, as described above, and proceeds to measure the PR in relation to each cell 20a-n in turn. The computer 150 carries out the calculation of BIF and shelf-life automatically, based on the input data already discussed.

It is important to ensure that each MC has an equal volume. Equal for each MC (ie each MC associated with each cell 20a-n) can be achieved in a number of ways, for example, by deliberately adjusting pipeline length from each cell 20a-n to/from measuring devices 132a-b, or by arranging the cells such that said cells are equidistant from said measurement-devices (eg in a circle), etc. Since the measured values of measurement-devices 132a-b relate to the MC-volume, these values must be related to absolute permeation rate by calibration. Calibration is carried out by injecting a known amount of each component into one MC, and monitoring the value given by measurement-device 132a-b. For this purpose, a known-quantity injection-device (eg syringe) can be connected to the coupling point 148 and a calibration amount injected by opening the calibration-valve 146.

Since measurement-device(s) 132a-b are mounted in a circuit outside the cells 20a-n, and are available to measure numerous containers (in contrast to the embodiment in FIG. 1, where each cell has its own, directly-mounted measurement-device), said measurement-device(s) can be selected for high sensitivity, without prejudicing the stated objective of measuring many packages 10 per day at relatively low cost. Additionally, in practice, it has been shown that measurement-devices, which are not directly mounted to a cell 20, are sensitive enough to permit a cell to be sized so as to accept the largest package 10 in the package-range of interest, whereby the internal displacer 8, as shown in FIGS. 1, 4 and 5 is also unnecessary. This enables the stated objective of providing a measurement capability for whole range of sizes of package 10, without change-parts, or time-consuming adjustment.

According to the objects of the present invention, the system 120 delivers rapid results, within the constraints set by the natural physical parameters of the test substances and the material of package 1. For example, when package 1 is a 0.5 l PET bottle and filled with carbonated test substance or water, containing 4 volumes of carbon dioxide, a ST of 6/7 days is needed at 38° C. As described hereinbefore, this ST takes place outside the permeation measurement system 120, in a separate pre-conditioning chamber (state-of-art and not shown). After pre-conditioning (ie after elapse of ST), the package 10 can be installed in the permeation measurement system 120 for permeation measurement.

In the given example of the 0.5 l PET-bottle, permeation-time 13 to provide measurable permeation-quantity 40 is about 60-180 minutes (depending on characteristics of measurement-device 132a-b). Therefore, after 60-180 minutes, each cell 20a-n can be connected to a measurement-device 132a-b for measurement of permeation. Since the actual measurement of permeation-quantity 40 by a measurement-device 132a-b takes about 5 minutes, for the example given, the actual measurement-cycle in the permeation measurement system 120 takes between 1 and 3 hours. To said time of 1 to 3 hours must be added a few minutes for purging (ie displacing of air and unwanted gases, as described) of the MC, since said purging must be carried out between each measurement.

The purging of the cells 20a-n itself takes place while other cells are being measured, and is therefore not strictly additive to the measurement-cycle time. Therefore, the permeation measurement system 120 can deliver results in, say, 1 to 3 hours, after ST has elapsed (depending on test substance 16 and package materials). ST depends on natural, physical constraints, primarily temperature, pressure and type of permeating gas, and is the main factor, which determines the waiting time for results (although, as explained above, it has no influence on the capacity or the speed of system 120).

In most polymers, the permeation of water vapour is relatively fast, because it has a smaller molecule than other shelf-life determining gases, such as carbon dioxide or oxygen. Therefore, water can saturate the walls of the package 10 much more quickly, and reduce ST considerably. For example, when the package 10 is a PET bottle containing a carbonated beverage, the waiting time due to ST is much reduced for water compared with carbon dioxide, so permeation results can be obtained much earlier. Since the PR for water relates to PR for carbon dioxide, said water PR can be used as a quick-test to determine the permeation characteristics (PR, BIF, shelf-life) of carbon dioxide. The method of the permeation measurement system 120 is non-destructive, so one/two out of a large set of test-samples of packages 10 can be retested for carbon dioxide later, to cross-check that results on water can be safely extrapolated to give results for carbon dioxide. The measurement-device 132a-b can be the same for water and carbon dioxide, if an FTIR detector is used, further simplifying the option of using water as a quick-test for carbon dioxide.

The methods described with regard to the embodiment 120 in FIG. 7 demonstrate a method for automating and meeting the other objectives of the present invention, using the basic principle described with regard to the embodiment in FIG. 1. The said methods demonstrated by the embodiment 120 in FIG. 7 can also be applied to the basic principles of the embodiments in FIGS. 4 and 5 with similar advantages, if a particular application benefits from the said basic principles of the embodiments in FIGS. 4 and 5. The principal focus of the present invention is measurement of permeation characteristics (PR, BIF, shelf-life) of normally-pressurized PET-bottles, either filled with gas or carbonated or still test substance, so as to enable research or quality-control of barrier enhancing treatments.

FIG. 8 shows a modified version of the embodiment in FIG. 7. This embodiment includes a means of avoiding ingress of atmospheric gases into the test cells 20a-d, or into the circuit-pipes between the test cells and gas measurement-devices 132a and 132b, or into the said gas measurement-devices themselves. A gas cylinder 160, complete with a pressure regulator 162 supplies an inert carrier gas 164. When measuring oxygen in the permeation measurement system 120, inert carrier gas 164 is normally nitrogen, but if nitrogen is being measured, then another inert carrier gas, which does not interfere with the measurements, must be used. The inert carrier gas 164 passes to an inert gas-valve 166 and then to a gas-distributor 168 within the cabinet or first enclosure 152. The inert gas inlet valve 166 can also be switched to connect to a gas pressure-controller 170, whereby this can be a conventional liquid-containing bubbler-tube (as shown), which maintains a gas-pressure equivalent to the bubbler-tube immersion height. The cabinet 152 is first purged to eliminate its air content by opening the inert gas inlet valve 166 and simultaneously opening an inert gas purge-valve 172. The inert gas inlet valve 166 and the inert gas purge-valve 172 are interlocked, as shown diagrammatically in FIG. 8, so that they function in unison. During the period of purging of the first cabinet 152, the pressure regulator 162 is opened to provide high gas flow, so as to reduce the purging time.

When air has been purged out of the first cabinet 152, the inert gas purge-valve 172 is closed and the inert gas inlet valve 166 switched to connect with gas pressure-controller, whilst continuing to maintain the flow of the inert gas 164 to the first cabinet 152. For this phase, the pressure regulator 162 is turned down to reduce the gas flow to that needed only to replace gas leakage from the first cabinet 152 and to maintain a small positive gas pressure in the first cabinet 152 (eg 10 cm water gauge). This said positive gas pressure helps to reduce ingress of air into the first cabinet 152 during the measurement cycle to a degree, which eliminates possible interference of air with the function of measuring-devices 132a-b.

Where necessary, a a second cabinet or enclosure 174 can be placed around the measurement-devices 132a-b, and the associated pipe and valves. The air content in this second enclosure 174 can be purged, using an inert gas inlet valve 176, the gas distributor 177, and an inert gas purge valve 178, in the manner already described for the first cabinet 152. The inert gas inlet valve 176 can also be switched to connect to a gas pressure-controller 180, such as a conventional liquid-containing bubbler-tube, which maintains a gas-pressure equivalent to the bubbler-tube immersion height. During the measurement cycle, a small positive pressure of inert gas 164 can be maintained in the second enclosure 174, again as already described for the first cabinet 152.

Accordingly, preferred embodiments of this invention address the above-described limitations of existing systems and particularly provide one or more of the following:

accuracy and speed in obtaining results, particularly for low permeation rates;

ability to measure both gas-filled and test substance-filled packages, as well as unopened packages direct from the production line;

ability to measure pressurised or un-pressurised packages;

simple/inexpensive means of handling many samples per working day with minimal operator intervention and low operator skill;

means of measuring the permeation of several components, particularly CO2, O2, H2O, either simultaneously, or separately;

means of relating permeation to a shelf-life;

means of measuring shelf-life under varying ambient conditions;

means of determining the effect on shelf-life of each permeating component, and also the effect of the package's normal closure;

means of measuring a wide range of package sizes, without change-parts; and

means of investigating permeation changes through several stages of handling, without re-filling the package.

It should be understood that the foregoing relates to particular embodiment of the present invention, and that numerous changes may be made therein without departing from the scope of the invention as defined by the following claims.

We claim:

1. Method for measuring the gas permeation and shelf-life of a packaged product by using at least one packaged test substance comprising a sealed container and a test substance disposed in the container, the method comprising the steps of:
stabilizing the at least one packaged test substance so that the test substance permeates at a permeation rate out of the sealed container and the permeation rate of the test substance out of the sealed container is substantially free of effects of package expansion and saturation of container walls;
placing the at least one packaged test substance inside a first cell;
closing the first cell and displacing any air or unwanted gases from the first cell with a carrier gas different from the test substance;
filling the first cell with the carrier gas so that the carrier gas contacts the at least one packaged test substance and mixes with any of the test substance that permeates from the sealed container to form a gas mixture comprising the carrier gas and an amount of permeated test substance;
holding the at least one packaged test substance and the carrier gas in the first cell for at least a period of time sufficient for measurable permeation of the test substance out of the sealed container to occur;
thereafter, analysing the gas mixture to determine the amount of permeated test substance; and
determining the permeation rate of the test substance out of the sealed container based on analysis of the gas mixture.

2. Method as in claim 1 wherein the step of stabilizing is conducted remotely from the first cell.

3. Method as in claim 1 wherein the step of stabilizing is conducted in an environment which is controlled with respect to temperature or humidity or both.

4. Method as in claim 1 wherein the step of stabilizing includes allowing the container to become saturated with the test substance.

5. Method as in claim 1 wherein the at least one packaged test substance has an interior pressure greater than atmospheric pressure.

6. Method as in claim 1 wherein the at least one packaged test substance has an interior pressure greater than atmospheric pressure and the step of stabilizing includes allowing the container to reach maximum expansion and become saturated with the test substance.

7. Method as in claim 1 wherein the step of analysing the gas mixture comprises passing the gas mixture through a gas content measuring means.

8. Method as in claim 1 further comprising calculating the permeation rate of the test substance through the sealed container when the container is first filled with the test substance and sealed based on the permeation rate of the test substance as determined in the step of determining the permeation rate.

9. Method as in claim 1 further comprising the step of calculating shelf-life of the at least one packaged test substance based on the permeation rate of the test substance as determined in the step of determining the permeation rate, a calculation of the permeation rate of the test substance through the sealed container when the container is first filled with the test substance and sealed based on the permeation rate of the test substance as determined in the step of determining the permeation rate, and data on expansion and gas absorption characteristics of the sealed container.

10. Method as in claim 1 wherein the first cell is disposed in a first enclosure having an controlled environment.

11. Method as in claim 10 further comprising the step of maintaining the first enclosure at a predetermined temperature.

12. A method as in claim 11, wherein the inside of the first enclosure is purged of any air and unwanted gases and maintained with a small positive inert gas pressure.

13. Method as in claim 7 wherein the cell is disposed in a first enclosure, and said enclosure is purged of any air and unwanted gases and maintained at a small positive inert gas pressure and the gas content measuring means is disposed in a second enclosure maintained at a positive inert gas pressure over the gas content measuring means.

14. Method as in claim 1 wherein the at least one packaged test substance comprises a flat film and a flat film holder defining a holding space for the test substance on one side of a flat film and an open aperture defining a free surface on another side of the flat film so that the flat film holder can be placed in the first cell and the test substance can permeate from the holding space, through the flat film, and into the carrier gas in the first cell and be measured.

15. Method as in claim 1 wherein:
the test substance includes a plurality of test gases that are different from the carrier gas;
the stabilizing step comprises stabilizing the at least one packaged test substance in the presence of the test substance so that the plurality of test gases permeate at respective permeation rates from the sealed container and the permeation rates of the plurality of test gases out of the sealed container are substantially free of effects of package expansion and saturation of container walls;
the step of filling the first cell comprises filling the first cell so that the carrier gas contacts the at least one packaged test substance and mixes with any of the plurality of test gas that permeate at respective permeation rates from the sealed container to form a gas mixture comprising the carrier gas and respective amounts of permeated test gases;
the step of holding comprises holding the at least one packaged test substance in the first cell for at least a period of time sufficient for measurable permeation of the plurality of test gases out of the sealed container to occur;
the step of analysing includes analysing the plurality of test gases to determine the amounts of permeated test gases; and
the step of determining comprises determining the permeation rate of at least two of the plurality of test gases out of the sealed container.

16. Method as in claim 7 wherein the step of analysing the gas mixture comprises passing the gas mixture through a plurality of gas measuring means.

17. Method as in claim 7 the step of displacing comprises displacing a measurement circuit with an inert gas different from the test substance, the measurement circuit comprising the gas content measuring means.

18. Method as in claim 17 wherein the measurement circuit connects the first cell to the measuring means.

19. Method as in claim 7 further comprising calibrating the measuring means by injecting a predetermined quantity of the test substance into the measuring means.

20. Method as in claim 1 wherein the test substance comprises a material that generates gas.

21. Method as in claim 1 wherein the gas permeation and shelf-life of a plurality of packaged products are measured by using packaged test substances including the first packaged test substance, each packaged test substance comprising a sealed container and a test substance disposed in the container, the method further comprising the steps of:
stabilizing the plurality of packaged test substances so that the test substances permeate at a permeation rate out of the sealed containers and the permeation rate of the test substances out of the sealed containers is substantially free of effects of package expansion and saturation of container walls;
placing the plurality of packaged test substances including the first packaged test substance inside a respective plurality of cells including the first cell;
closing the plurality of cells and displacing any air or unwanted gases from the plurality of cells with the carrier gas;
filling the plurality of cells with the carrier gas so that the carrier gas contacts the plurality of packaged test substances and mixes with any of the test substances that permeate from the packaged test substances to form a gas mixture comprising the carrier gas and an amount of permeated test substance;
holding the plurality of packaged test substances and the carrier gas in the respective ones of the plurality of cells for at least a period of time sufficient for measurable permeation of the test substances out of the sealed containers to occur;
thereafter, selectively analysing the gas mixture from each of the plurality of cells to determine the amount of permeated test substance; and
determining the permeation rate of the test substances out of the sealed containers based on analysis of the gas mixture from each of the plurality of cells.

22. Method as in claim 1 wherein the container is selected from a variety of different sized containers and the first cell is sized to accommodate different sized containers.

23. Method as in claim 1 wherein the method further comprises calculating the permeation rate of another substance, different from the test substance, based on the permeation rate of the test substance.

24. Method as in claim 23 wherein the test substance is selected from the group consisting of helium and water vapor.

25. Method as in claim 1 wherein the test substance includes carbon dioxide.

26. Method as in claim 1 wherein the test substance includes a gas selected from the group consisting of carbon dioxide, oxygen, and water.

27. Method as in claim 1 wherein the test substance is a carbonated beverage.

28. Method as in claim 1 wherein the container comprises polyethylene terephthalate.

29. Method for measuring the gas permeation and shelf-life characteristics of at least one container having an opening, the method comprising the steps of:
placing the at least one container inside a first cell having a gas inlet and a gas outlet so that the at least one container is fixed and sealed to the first cell so as to seal an interior of the container from a space inside the first cell between the first cell and the at least one container;
closing the first cell;
filling the at least one container with a test substance and displacing any air and unwanted gases from the at least one container;
stabilizing the at least one container so that the test substance permeates at a permeation rate out of the at least one container and the permeation rate of the test substance out of the at least one container is substantially free of effects of package expansion and saturation of container walls;
displacing any air or unwanted gases from the first cell with a carrier gas different from the test substance;
filling the space in the first cell with the carrier gas so that the carrier gas contacts the at least one container and mixes with any of the test substance that permeates from the at least one container to form a gas mixture comprising the carrier gas and an amount of permeated test substance and displacing any air and unwanted gases from the first cell;
holding the at least one container and the carrier gas in the first cell for at least a period of time sufficient for measurable permeation of the test substance out of the at least one container to occur;
thereafter, analysing the gas mixture to determine the amount of permeated test substance; and
determining the permeation rate of the test substance out of the at least one container based on analysis of the gas mixture.

30. Method as in claim 29 wherein the step of stabilizing includes allowing the at least one container to become saturated with the test substance.

31. Method as in claim 29 wherein the step of filling the at least one container comprises pressurizing the at least one container to an interior pressure greater than atmospheric pressure and the method further comprises maintaining the interior pressure greater than atmospheric pressure during the steps of stabilizing, filling the space in the first cell, and holding.

32. Method as in claim 31 wherein the step of stabilizing further comprises allowing the at least one container to reach maximum expansion and become saturated with the first test gas.

33. Method as in claim 29 wherein the step of analysing the gas mixture comprises passing the gas mixture through a gas content measuring means.

34. Method as in claim 29 further comprising calculating the permeation rate of the test substance through at least one container when the at least one container is first filled with the test substance based on the permeation rate of the test substance as determined in the step of determining the permeation rate.

35. Method as in claim 29 further comprising the step of calculating shelf-life of the at least one container based on the permeation rate of the test substance as determined in the step of determining the permeation rate, a calculation of the permeation rate of the test substance through the at least one container when the at least one container is first filled with the test substance based on the permeation rate of the test substance as determined in the step of determining the permeation rate, and data on expansion and gas absorption characteristics of the at least one container.

36. Method as in claim 29 wherein the first cell is disposed in an enclosure having an controlled environment.

37. Method as in claim 36 further comprising the step of maintaining the enclosure at a predetermined temperature.

38. Method as in claim 29 wherein:
the test substance comprises a plurality of test gases;
the step of filling the first container includes filling the first container with the plurality of test gases;
the step of stabilizing the first container comprises stabilizing the at least one container so that the plurality of test gases permeate at respective permeation rates from the at least one container and the permeation rates of the plurality of test gases out of the at least one container are substantially free of effects of package expansion and saturation of container walls, the plurality of test gases including the test substance and being different from the carrier gas;
the step of filling the space in the first cell with the carrier gas comprises filling the space so that the carrier gas contacts the at least one container and mixes with any of the plurality of test gases that permeate at respective permeation rates from the at least one container to form a gas mixture comprising the carrier gas and respective amounts of permeated test gases;
the step of holding includes holding the at least one container and the carrier gas in the first cell for at least a period of time sufficient for measurable permeation at least two of the plurality of test gases out of the at least one container to occur;
the step of analysing includes analysing the plurality of test gases to determine the amounts of permeated test gases; and
the step of determining comprises determining the permeation rate of the at least two of the plurality of test gases out of the at least one container.

39. Method as in claim 38 wherein the step of analysing the gas mixture comprises passing the gas mixture through a plurality of gas measuring means.

40. Method as in claim 33 wherein the step of displacing comprises displacing a measurement circuit with an inert gas different from the test substance, the measurement circuit comprising the gas content measuring means.

41. Method as in claim 40 wherein the measurement circuit connects the first cell to the measuring means.

42. Method as in claim 33 further comprising calibrating the measuring means by injecting a predetermined quantity of the test substance into the measuring means.

43. Method as in claim 29 wherein the container is selected from a variety of different sized containers and the first cell is sized to accommodate different sized containers.

44. Method as in claim 29 wherein the method further comprises calculating the permeation rate of another substance, different from the test substance, based on the permeation rate of the test substance.

45. Method as in claim 44 wherein the test substance is selected from the group consisting of helium and water vapor.

46. Method as in claim 29 wherein the gas permeation and shelf-life characteristics of a plurality of containers including the at least one container are measured, the method further comprising the steps of:
placing the plurality of containers including the at least one container inside a respective plurality of cells including the first cell, so that the plurality of containers are fixed and sealed to respective ones of the cells so as to seal an interior of the containers from a space inside the plurality of cells between the cells and the containers;
closing the plurality of cells;
filling the plurality of containers with the test substance and displacing any air and unwanted gases from the plurality of containers;
stabilizing the plurality of containers so that the test substance permeates at a permeation rate from the plurality of containers and the permeation rate of the test substance out of the plurality of containers is substantially free of effects of package expansion and saturation of container walls;
displacing any air or unwanted gases from the plurality of cells with a carrier gas different from the test substance;
filling the space in each of the plurality of cells with the carrier gas so that the carrier gas contacts the plurality of containers and mixes with any of the test substance that permeates at a permeation rate out of the plurality of containers to form a gas mixture comprising the carrier gas and an amount of permeated test substance;
holding the plurality of containers in the respective ones of the plurality of cells for at least a period of time sufficient for measurable permeation of the test substance out of the plurality of containers to occur;
thereafter, selectively analysing the gas mixture from each of the plurality of cells to determine the amount of permeated test substance; and
determining the permeation rate of the test substance out of the containers based on analysis of the gas mixture from each of the plurality of cells.

47. Method as in claim 29 wherein the test substance includes carbon dioxide.

48. Method as in claim 29 wherein the test substance includes a gas selected from the group consisting of carbon dioxide, oxygen, and water.

49. Method as in claim 29 wherein the test substance is a carbonated beverage.

50. Method as in claim 29 wherein the first container comprises poly (ethylene terephthalate).

51. Method as in claim 29 wherein the at least one container comprises plastic.

52. Method for measuring the gas permeation and shelf-life characteristics of at least one container having an opening, the method comprising the steps of:
placing the at least one container inside a first cell so that the at least one container is fixed and sealed to the first cell so as to seal an interior of the container from a space inside the first cell between the first cell and the at least one container;
closing the first cell;
filing the at least one container with a carrier gas different from the test substance and displacing any air and unwanted gases from the at least one container;
filling the space in the first cell with a test substance and displacing any air and unwanted gases from the first cell;
stabilizing the at least one container so that the test substance permeates at a permeation rate through the at least one container and the permeation rate of the test substance through the at least one container is substantially free of effects of package expansion and saturation of container walls;
displacing from the at least one container with the carrier gas any test substance that entered the at least one container during the step of stabilizing;
holding the at least one container in the first cell and the carrier gas in the at least one container for at least a period of time sufficient for measurable permeation of the test substance into the at least one container to occur at a permeation rate and form a gas mixture comprising the carrier gas and an amount of permeated test substance;
thereafter, analysing the gas mixture to determine the amount of permeated test substance; and
determining the permeation rate of the test substance into the first container based on analysis of the gas mixture.

53. Method as in claim 52 wherein the step of stabilizing includes allowing the container to become saturated with the test substance.

54. Method as in claim 52 wherein the step of filling the first cell comprises pressurizing the first cell to an interior pressure greater than atmospheric pressure and the step of filling the at least one container comprises pressurizing the at least one container to an interior pressure greater than atmospheric pressure and the method further comprises maintaining the interior pressure of the cell and the container greater than atmospheric pressure during the steps of stabilizing and holding.

55. Method as in claim 54 wherein the step of stabilizing further comprises allowing the at least one container to become saturated with the test substance.

56. Method as in claim 52 wherein the step of analysing the gas mixture comprises passing the gas mixture through a gas content measuring means.

57. Method as in claim 52 further comprising calculating the permeation rate of the test substance through at least one container when the at least one container is first filled with the test substance based on the permeation rate of the test substance as determined in the step of determining the permeation rate.

58. Method as in claim 52 further comprising the step of calculating shelf-life of the at least one container based on the permeation rate of the test substance as determined in the step of determining the permeation rate, a calculation of the permeation rate of the test substance through the at least one container when the at least one container is first filled with the test substance based on the permeation rate of the test substance as determined in the step of determining the permeation rate, and data on expansion and gas absorption characteristics of the at least one container.

59. Method as in claim 52 wherein the first cell is disposed in an enclosure having an controlled environment.

60. Method as in claim 59 further comprising the step of maintaining the enclosure at a predetermined temperature.

61. Method as in claim 52 wherein:
the test substance includes a plurality of test gases;
the step of filling first cell includes filling the space in the first cell with the plurality of test gases so that the carrier gas contacts the first container and mixes with any of the plurality of test gases that permeate at respective permeation rates into the at least one container to form a gas mixture comprising the carrier gas and respective amounts of permeated test gases;
the step of stabilizing the first container comprises stabilizing the first container so that the plurality of test gases permeate at respective permeation rates through the at least one container and the permeation rates of the plurality of test gases through the at least one container are substantially free of effects of package expansion and saturation of container walls, the plurality of test gases being different from the carrier gas;
the step of holding includes holding the at least one container in the first cell and the carrier gas in the at least one container for at least a period of time sufficient for measurable permeation at least two of the plurality of test gases into the at least one container to occur and form a gas mixture comprising the carrier gas and an amount of permeated test gases;
the step of analysing includes analysing the gas mixture to determine the amounts of permeated test gases; and
the step of determining comprises determining the permeation rate of the at least two of the plurality of test gases into the at least one container.

62. Method as in claim 61 wherein the step of analysing the gas mixture comprises passing the gas mixture through a plurality of gas measuring means.

63. Method as in claim 56 wherein the step of displacing comprises displacing a measurement circuit with an inert gas different from the test substance, the measurement circuit comprising the gas content measuring means.

64. Method as in claim 63 wherein the measurement circuit connects the first cell to the measuring means.

65. Method as in claim 56 further comprising calibrating the measuring means by injecting a predetermined quantity of the test substance into the measuring means.

66. Method as in claim 52 wherein the gas permeation and shelf-life characteristics of a plurality of containers including the first container are measured, the method further comprising the steps of:
placing the plurality of containers including the first container inside a respective plurality of cells including the first cell so that the plurality of containers are fixed and sealed to respective ones of the cells so as to seal an interior of the containers from a space inside the plurality of cells between the cells and the containers;
closing the plurality of cells;
filing the plurality of containers with the carrier gas and displacing any air and unwanted gases from the plurality of containers;
filling the space in each of the plurality of cells with the test substance and displacing any air and unwanted gases from the plurality of cells;
stabilizing the plurality of containers so that the test substance permeates at a permeation rate through the plurality of containers and the permeation rate of the test substance through the plurality of containers is substantially free of effects of package expansion and saturation of container walls;
displacing from the plurality of containers with the carrier gas of the test substance that entered the plurality of containers during the step of stabilizing;
holding the plurality of containers in the respective ones of the plurality of cells and the carrier gas in the plurality of containers for at least a period of time sufficient for measurable permeation of the test substance into the plurality of containers to occur and form a gas mixture comprising the carrier gas and an amount of permeated test substance;
thereafter, selectively analysing the gas mixture from each of the plurality of containers to determine the amount of permeated test substance; and
determining the permeation rate of the test substance into the containers based on analysis of the gas mixture from each of the plurality of containers.

67. Method as in claim 52 wherein the container is selected from a variety of different sized containers and the first cell is sized to accommodate different sized containers.

68. Method as in claim 52 wherein the method further comprises calculating the permeation rate of another substance, different from the test substance, based on the permeation rate of the test substance.

69. Method as in claim 68 wherein the test substance is selected from the group consisting of helium and water vapor.

70. Method as in claim 52 wherein the test substance includes carbon dioxide.

71. Method as in claim 52 wherein the test substance is a gas selected from the group consisting of carbon dioxide, oxygen, and water.

72. Method as in claim 52 wherein the test substance is a carbonated beverage.

73. Method as in claim 52 wherein the first container comprises poly (ethylene terephthalate).

74. Method as in claim 52 wherein the first container comprises plastic.
